(19) United States
(12) Patent Application Publication
(10) Pub. No.: US 2017/0016809 A1
(43) Pub. Date: Jan. 19, 2017

(54) ICED CONDUCTOR SLEET JUMP SIMULATION TESTING METHOD

(71) Applicant: Graduate School at Shenzhen, Tsinghua University, Shenzhen (CN)

(72) Inventors: Liming WANG, Shenzhen (CN); Hongwei MEI, Shenzhen (CN); Xiaobo MENG, Shenzhen (CN); Yayun GAO, Shenzhen (CN); Lei HOU, Shenzhen (CN); Guanjun FU, Shenzhen (CN); Chuang WANG, Shenzhen (CN)

(21) Appl. No.: 15/281,580

(22) Filed: Sep. 30, 2016

Related U.S. Application Data
(63) Continuation of application No. PCT/CN2014/076685, filed on Apr. 30, 2014.

(30) Foreign Application Priority Data
Apr. 1, 2014 (CN) 201410132356.0

(51) Int. Cl. G01N 3/08; G01B 21/00

(52) U.S. Cl. CPC G01N 3/08; G01B 21/00

(57) ABSTRACT

An iced conductor sleet jump simulation testing method is disclosed, where after an initial tension of a conductor and an initial displacement of the conductor in a static state are obtained by using a combination of a given meteorological condition and a typical meteorological condition, displacement and tension states of the conductor in a dynamic state at each discrete moment can be accurately and reliably predicted until a specific time arrives.

### BACKGROUND

Technical Field

The present application relates to designing and testing of a high-voltage power transmission line, and in particular, to an iced conductor sleet jump simulation testing method.

Related Art

An overhead power transmission line runs in the atmospheric environment for a long term and is interfered by non-human factors such as wind and icing. China is a country having the most severe icing problem, and a probability that a line icing damage accident occurs in China ranks high in the world. One of the three harmful effects of icing on the power transmission line is a stress difference generated from uneven icing or asynchronous deicing, which may electrically cause an inter-phase short-circuit trip and flashover and mechanically forms a relatively great unbalanced tension on an insulator string and a pole tower to damage an insulator and even cause breakdown of the pole tower, which would directly threaten safe running of a power system. In addition, with the unprecedented expansion of the construction scale of hydroelectric resources in the development of the western region in China, ultra-long-distance ultra- or extra-high voltage power transmission needs to pass through severe-cold, high-humidity, heavily-iced, and high-altitude regions, the icing damage problem of the power transmission line is more prominent, where the iced conductor sleet jump problem is one of the contents that need to developed and researched deeply. With the vigorous development of extra-high voltage grids in China, the sectional area of a conductor increases, the number of divisions increases, and the conductor sleet jump problem needs to be researched more deeply.

A conductor deicing jumping process mainly includes three processes: (1) a process of icing a conductor; (2) under conditions such as a specific temperature, a wind load, and an external force, the conductor is deiced, and the conductor jumps; (3) after a long-time oscillation process, the conductor achieves new stress and sag states. Currently, researches on the conductor sleet jump problem of a power transmission line mainly use experiments and numerical simulation methods at home and abroad. The simulation experiment is impeded because of its high costs and weak expansibility of a conclusion. In an aspect of numerical simulation, Jamaleddine, Mcclure, et al. carried out numerical simulation of multiple sleet jump working conditions by using finite element software ADINA; Kalman researches responses, such as a ground wire displacement and a tension, under different spans, pulse loads, and deicing working conditions by using a finite element numerical method and researches an impact of a deicing method on a ground wire, and Roshan Fekr et al. uses a single-conductor power transmission line as an object to research impacts of factors, such as the thickness of icing and the deicing position, on a sleet jump process. Some scholars in China also carry out simulation testing researches. Generally speaking, because of complexity of actual line parameters, for example, factors, such as a mechanical parameter of a conductor, a span combination, a height difference, a length of an insulator string, dynamic damping of the conductor, would all exert notable impacts on a sleet jump process of the conductor, it would be difficult for a computer model to accurately simulate an actual situation of a line, and meanwhile accuracy of a simulation result also is not verified by an experiment. Currently, with regard to consideration on a sleet jump in line designing, verification and calculation are generally performed according to empirical equations. Running experience indicates that an empirical equation have a specific guiding meaning for anti-sleet jump designing of a line. However, the empirical equation does not provide an applicable range and many factors that affect the conductor sleet jump are not completely considered, so that the empirical equation still have disadvantages. In conclusion, current researches on the conductor sleet jump problem in China are not mature and researches on simulation testing for the conductor sleet jump problem are necessary.

### SUMMARY

A main object of the present application is providing an iced conductor sleet jump simulation testing method, capable of reliably measuring and calculating displacement and stress states at a conductor sleet jump discrete moment under a given meteorological condition.

In order to achieve the foregoing object, the present application uses the following technical solutions:

An iced conductor sleet jump simulation testing method, including the following steps:

(1) setting a maximum value (σ_{I}) in a conductor stress under a given typical meteorological condition combination to a conductor allowable maximum use stress and obtaining a stress (σII) of the conductor under a testing meteorological condition by using the following conductor stress state equation:

$${σ}_{I} - \frac{{EL}^{2} {γ}_{I}^{2}}{24 {σ}_{I}^{2}} + α {Et}_{I} = {σ}_{II} - \frac{{EL}^{2} {γ}_{II}^{2}}{24 {σ}_{II}^{2}} + α {Et}_{II} ,$$

where:

the subscript I represents a typical meteorological condition, the subscript II represents a testing meteorological condition, σ_{I} is a conductor middle-span allowable maximum stress, σ_{II} is a conductor middle-span stress under the testing meteorological condition, E is a comprehensive elastic coefficient of the conductor, α is a coefficient of thermal expansion, t_{I} is a temperature under the typical meteorological condition, t_{II} is a temperature under the testing meteorological condition, γ_{I} is a relative load of an overhead conductor under the typical meteorological condition, γ_{II} is a relative load of the overhead conductor under the testing meteorological condition, and

$$γ = \frac{q}{A} ,$$

where q is a load withstood by the conductor of a unit length, A is a sectional area of the conductor, and L is a representative span of a strain section;

(2) according to the conductor stress and the load obtained in step (1), obtaining a displacement initial state of the conductor by using the following conductor catenary equation:

$$y = \frac{{σ}_{0}}{γ} [ cosh \frac{γ}{{σ}_{0}} ( z - {z}_{0} ) ] + {y}_{0} ,$$

where:

z is a known horizontal coordinate of each point in a current testing span along a line direction, y is a to-be-measured-and-calculated vertical coordinate of each point, z₀ and y₀ are constant parameters:

$${z}_{0} = \frac{1}{2 γ l} ( γ {l}^{2} - 2 H {σ}_{0} )$$

$${y}_{0} = - \frac{1}{8 γ {σ}_{0} {l}^{2}} ( γ {l}^{2} - 2 H {σ}_{0} ) ,$$

and

an x coordinate of each point in a static state is consistent and given, where:

σ₀ is a stress of the lowest point of the conductor, and a relationship between σ₀ and the conductor middle-span stress σ_{II} satisfies:

$${σ}_{II} = \frac{{σ}_{0}}{cos β} ,$$

where β is a height difference angle, H is a height difference between two suspending points, and when the suspending point on the right side is higher than the suspending point on the left signal, the height difference is a positive value; and I is a span of each span of the strain section; and

(3) according to the displacement initial state, obtaining displacement and stress states of each point in the current testing span of the conductor at each to-be-tested moment by using the following conductor kinetic equation:

M\ddot{X}=P+F_{C}+T, where:

M, F_{C}, T, and P are a mass matrix, a damping matrix, a tension matrix, and an external force matrix respectively, the mass matrix M being a diagonal matrix; F_{C}=C\dot{X}, where C is a damping coefficient; T=KX, where K a stiffness matrix related to x, y, z coordinates of an adjacent node and is represented as a ratio of a dynamic tension between two adjacent points and a deformation amount thereof; X is a displacement, \dot{X} is a speed, and \ddot{X} is acceleration; and X, \dot{X}, and \ddot{X} are all three-dimensional vectors and include three directions of x, y, z.

Preferably, in step (1), a group of typical meteorological conditions is selected from multiple known groups of typical meteorological conditions to serve as the given typical meteorological condition, and the group of typical meteorological conditions is the group of typical meteorological conditions that makes a conductor stress closest to the conductor allowable maximum stress among the multiple groups of typical meteorological conditions

Preferably, in step (1), the representative span L of the conductor is calculated by using the following equation:

$$L = \sqrt{\frac{{\sum }_{1}^{n} {l}_{i 0}^{3}}{{\sum }_{1}^{n} {l}_{i 0}}} ,$$

where Iᵢ₀ a span of each span in an n-span conductor, i0=1, 2, . . . , n. Preferably, in step (1), the load q is calculated by using the following equation:

$$q = P = \sqrt{{( {P}_{1} + {P}_{2} )}^{2} + {P}_{3}^{2}} , where {P}_{1} = WG , \\ {P}_{2} = \frac{ρ π G ( b + d ) b}{{10}^{6}} , and {P}_{3} = {Av}^{2} ( d + 2 b ) ,$$

where:

W is the mass of the conductor, G is a gravitational acceleration length, ρ is air density, b is the thickness of icing, d is the outer diameter of the conductor, and v is a wind speed.

Preferably, in step (3), the displacement and stress states are measured and calculated by using an explicit direct integration algorithm based on a central difference, so that speed and acceleration vectors are:

$$\dot{X} ( t ) = \frac{X ( t + Δ t ) - X ( t - Δ t )}{2 Δ t} ; and$$

$$\ddot{X} ( t ) = \frac{X ( t + Δ t ) + X ( t - Δ t ) - 2 X ( t )}{Δ {t}^{2}} ,$$

where:

Δt is a calculated step length, and Δt≦2/ωₙ, where ωₙ is a maximal order inherent vibration frequency of a system.

Beneficial technical effects of the present application:

According to a conductor sleet jump simulation measuring and calculating method of the present application, after an initial tension of a conductor and an initial displacement of the conductor in a static state are obtained by using a combination of a given meteorological condition and a typical meteorological condition, displacement and tension states of the conductor in a dynamic state at each discrete moment can be accurately and reliably predicted until a specific time arrives. By means of the displacement and tension states of the conductor obtained in a dynamic process according to the measuring and calculating method of the present application, influencing rules of factors, such as an amount of deicing, the thickness of icing, a magnitude of a span, a number of spans, a height difference between conductor suspending points, and an uneven deicing manner, on a sleet jump height and a longitude unbalanced tension of a power transmission line can be effectively obtained by means of analysis.

### BRIEF DESCRIPTION OF THE DRAWINGS

FIG. 1a and FIG. 1b are schematic diagrams of a 3-degrees of freedom model of a continuous span of an overhead power transmission conductor;

FIG. 2 is a flowchart of an embodiment of a conductor sleet jump simulation measuring and calculating method according to the present application; and

FIG. 3 is a diagram of comparison between a tested conductor jump displacement curve and a conductor jump displacement in experimental simulation according to a method embodiment of the present application.

### DETAILED DESCRIPTION

Embodiments of the present application are described in detail below with reference to the accompanying drawings. It should be emphasized that the following descriptions are merely illustrative and are not intended to limit the scope and application of the present invention.

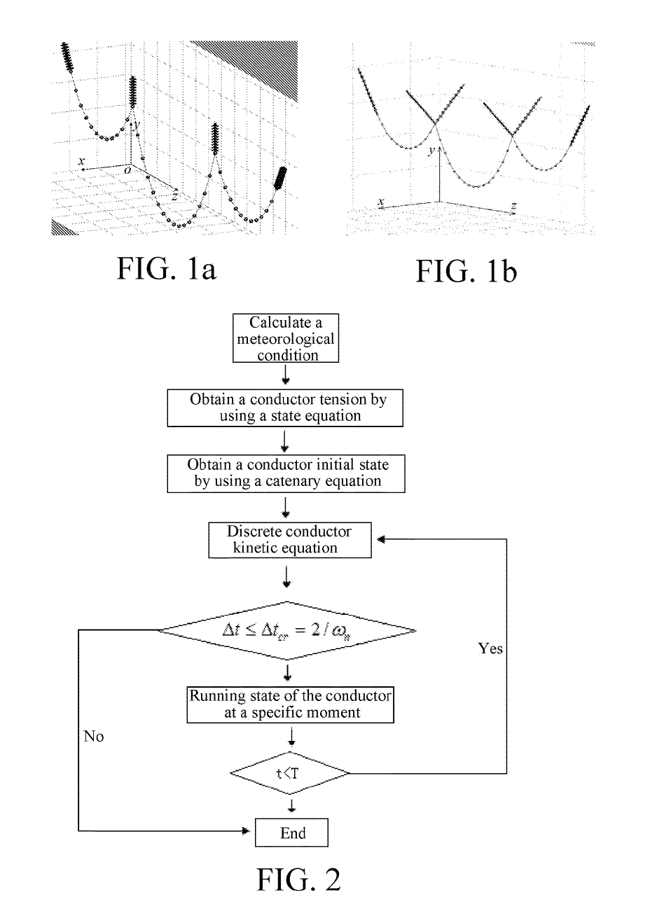

FIG. 1a and FIG. 1b show a 3-degrees of freedom model of a continuous span of a to-be-simulation-tested overhead power transmission conductor;

As shown in FIG. 2, according to embodiments of the present application, a conductor sleet jump simulation measuring and calculating method includes two procedures, namely, static processing and dynamic processing procedures, where the static processing procedure provides a measured and calculated initial value for the dynamic processing procedure (before t<0, the conductor reaches a state), that is, an initial state of the conductor before the jump, and the dynamic processing uses the initial state to measure and calculate displacement and tension states of each point of the conductor at a to-be-tested discrete moment.

I. Static Processing Procedure of the Conductor

Static processing obtains a suspending state (for example, each point sags) and a stress state of the conductor under a given meteorological condition and line parameter. The static processing includes: measuring and calculating a conductor stress under a testing meteorological condition by using parameters, such as a static load of the given meteorological condition and a conductor stress, that are measured in advance and measuring and calculating an initial displacement of the conductor according to the load and stress (a z-y relationship, where an x is consistent and given).

(1) Measuring and Calculating a Static Stress of the Conductor

The stress under a given typical meteorological condition I and a testing meteorological condition II satisfies a state equation:

$${σ}_{I} - \frac{{EL}^{2} {γ}_{I}^{2}}{24 {σ}_{I}^{2}} + α {Et}_{I} = {σ}_{II} - \frac{{EL}^{2} {γ}_{II}^{2}}{24 {σ}_{II}^{2}} + α {Et}_{II} \qquad ( Equation 1 )$$

σ_{I} is a conductor allowable maximum stress (the middle-span), σ_{II} is a conductor stress under the testing meteorological condition, E is a comprehensive elastic coefficient of the conductor, α is a coefficient of thermal expansion, t_{I} is a temperature, and L is a representative span of a strain section, which may be calculated by using the equation

$$L = \sqrt{\frac{{\sum }_{1}^{n} {l}_{i 0}^{3}}{{\sum }_{1}^{n} {l}_{i 0}}} ,$$

where Iᵢ₀ a span of each span of the conductor, γ is a relative load of an overhead conductor (that is, a ratio of a load withstood by a conductor of a unit length to a sectional area of the conductor), and

$$γ = \frac{q}{A} ,$$

where q is a load withstood by the conductor of a unit length, and A is a sectional area of the conductor. The subscripts I and II represent that the parameters are parameters respectively corresponding to the typical meteorological condition I and the testing meteorological condition II.

A span refers to a projection distance vertical to a load direction between two adjacent suspending points.

A designing object of a tension sage of an overhead power transmission line conductor is using a relatively great stress to obtain a relative small conductor sag as much as possible and ensuring that a maximum stress of the conductor under various allowable meteorological condition combinations is smaller than or equal to the allowable maximum conductor stress.

Preferably, with regard to multiple given typical meteorological condition combinations, a procedure of determining a conductor stress is: first comparing magnitudes of conductor stresses under multiple typical meteorological condition conditions, making a maximum value of the conductor stress in the typical meteorological condition combination reach a conductor allowable maximum use stress, that is, mounting the conductor in this state to tension the conductor, using the group of typical meteorological conditions corresponding to the maximum value as the given typical meteorological condition, and on the basis of the above, obtaining stresses of the conductor in rest meteorological conditions by using the state equation of the equation (1).

Since the date of setup, the conductor is subject to load effects such as gravity of the conductor, icing, and wind, which constitute q (or γ). A preferable manner of measuring and calculating the static load q of the conductor is as the following table, where q=P:

TABLE 1
Static load of the conductor

| Load type | Calculation equation | Note |
|---|---|---|
| Self weight | P₁ = WG | W is the mass of the |
| | | conductor; and G is a |
| | | gravitational acceleration |
| | | length, which is 9.8 ^{m/s}^{²}; |
| Icing amount | ${P}_{2} = \frac{ρπg ( b + d ) b}{{10}^{6}}$ | b it the thickness of icing, measured by mm; and d is the outer diameter of the conductor, measured by mm; |
| Wind load | P₃ = Av² (d + 2b) | A is a sectional area of the |
| during icing | | conductor; and v is a wind |
| | | speed; |
| Total load | P = \sqrt{(P₁ + P₂)² + P₃²} | |

(2) Measuring and Calculating an Initial Displacement State of the Conductor

A relationship between the stress of the lowest point σ₀ and the conductor middle-span stress σ_{II} satisfies:

$${σ}_{II} = \frac{{σ}_{0}}{cos β} ,$$

where β is a height difference angle.

Because a distance between suspending points of an overhead power transmission conductor is relatively great, and the stiffness of a conductor material has an excessively small impact on a geometric shape of the conductor, the conductor is generally assumed as a flexible chain that is hingedly connected throughout, that is, the assumption of “a catenarian”. The conductor static suspending equation (namely, a catenary equation of the conductor) according to the assumption is:

$$y = \frac{{σ}_{0}}{γ} [ cosh \frac{γ}{{σ}_{0}} ( z - {z}_{0} ) ] + {y}_{0} \qquad ( Equation 2 )$$

z is a known horizontal coordinate (along a line direction) of each point in a current testing span, y is a to-be-calculated vertical coordinate of each point, z₀ and y₀ are constant parameters:

$${z}_{0} = \frac{1}{2 γ I } ( γ {I}^{2} - 2 H {σ}_{0} ) \\ where \\ {y}_{0} = - \frac{1}{8 γ {σ}_{0} {I}^{2}} ( γ {I}^{2} - 2 H {σ}_{0} ) \qquad ( Equation 3 )$$

H is a height difference between two suspending points, and when the suspending point on the right side is higher than the suspending point on the left signal, the height difference is a positive value.

II. Dynamic Processing Procedure of the Conductor

The conductor kinetic equation for measuring and calculating conductor displacement and tension states of the conductor at a discrete moment is:

M\ddot{X}=P+F_{C}=T (Equation 4)

M, F_{C}, T, and P are a mass matrix, a damping matrix, a tension matrix, and an external force matrix respectively. X is a displacement, \dot{X} is a speed, and \ddot{X} is acceleration. An assumption of node unit mass concentration is used, and the mass matrix M is a diagonal matrix; F_{C}=C\dot{X}, where C is a damping coefficient, which can be selected according to engineering experience; T=KX, where K a stiffness matrix, which is determined according to a dynamic tension between two adjacent points and a deformation amount thereof, and the deformation may be determined according to the calculation on the displacement of the conductor in the preceding text and includes three directions of x, y, z.

The conductor sleet jump is a strongly nonlinear dynamic procedure, preferably, an explicit direct integration algorithm based on a central difference is used, and speed and acceleration vector in the method are:

$$\begin{matrix}\dot{X} ( t ) = \frac{X ( t + Δ t ) - X ( t - Δ t )}{2 Δ t} & ( Equation 5 ) \\ \ddot{X} ( t ) = \frac{X ( t + Δ t ) + X ( t - Δ t ) - 2 X ( t )}{Δ {t}^{2}} & ( Equation 6 )\end{matrix}$$

The central difference explicit algorithm is a condition convergence algorithm, and a step length satisfies:

Δt≦2/ωₙ (Equation 7)

ωₙ is a maximal order inherent vibration frequency of a system.

Conductor Sleet Jump Calculation Model

A common conductor dynamic analysis model usually only considers a situation of a single span and considers that a moving unit merely performs a 2-degrees of freedom of transitional movement within an XY vertical plane. Precision of this type of model can basically satisfy requirements in a movement of a small span and a small amplitude, but in a case of a multi-span conductor and in a case that the conductor obviously swings in the Z-axis direction, this type of model has a relatively large error. Therefore, this type of model cannot satisfy a situation of uneven deicing of a continuous-span conductor. To simulate, measure, and calculate a motion state of a deicing procedure of an overhead power transmission conductor, a following dynamic model of multi-span concentrated mass of the overhead power transmission conductor is established.

The conductor is segmented into several conductor elementary sections, the mass of the conductor is concentrated on the node of the conductor, mass points are connected by using an elastic element without mass, that is, connected by using a tension, and its bending and turning stiffness is not taken into consideration. Each mass point may transitional move (3 degrees of freedom) in a space (X, Y, and Z), and a series of external forces, such as loads, such as a self weight load, an icing load, and a wind load, distributed on the whole conductor length and a tension of an insulator string at a suspending point, that the conductor may withstand in a running environment are taken into consideration. For each node unit, its dynamic equation, namely, (Equation 4), is listed. Because of the elastic connection between mass points, the tension matrix T is a non-diagonal matrix (which is not 0 between adjacent points).

Measurement and Calculation Instance

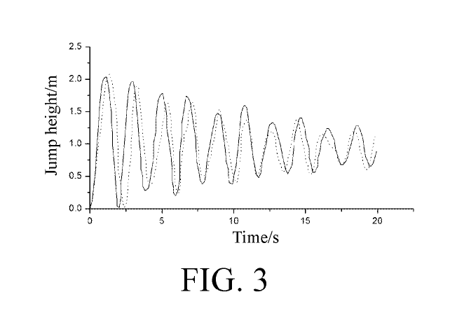

Refer to FIG. 3 for conductor sleep amplitude changing curves in simulation measurement and calculation and experimental simulation in a case in which a single span has a span of 235 m and icing of 15 mm and is iced by 100%.

It could be known from FIG. 3 that in the case in which the single span is deiced by 100%, a digital simulation curve of the conductor jump amplitude is basically consistent with an experimental curve. Experimental working conditions of a single span are completely simulated, and under various working conditions of the single span, comparison between conductor jump amplitude simulation calculation results and experimental results is as the table.

TABLE 1
Comparison between conductor jump amplitudes under simulation
calculation and experimental simulation

| Experimental | Conductor jump amplitude | | |
|---|---|---|---|
| working | | Numerical | |
| conditions | Experiment/m | simulation/m | Error (%) |
| 1 | 0.63 | 0.58 | −7.94% |
| 2 | 0.84 | 0.90 | 7.14% |
| 3 | 1.05 | 1.12 | 9.52% |
| 4 | 0.45 | 0.48 | 6.67% |
| 5 | 1.28 | 1.30 | 1.56% |
| 6 | 2.09 | 2.03 | −2.87% |
| 7 | 1.27 | 1.37 | 7.87% |
| 8 | 1.76 | 1.85 | 5.11% |
| 9 | 2.01 | 1.93 | −3.98% |

$\begin{matrix}( Note \text{:} \\ in the table , Error = \frac{\vert Experiment - Numerical simulation \vert}{Experiment} \times 100 \% )\end{matrix}$

It could be known from the comparison between the measurement and calculation results and the simulation experiment results that, in a case of a single span, under the condition that the same measurement and calculation conditions and simulation working conditions are used, the measurement and calculation results of the conductor jump amplitude are basically consistent with the simulation experiment results (the errors are all less than 10%).

The foregoing content is detailed description of the present application with reference to the specific preferred embodiments, but it cannot be considered that the specific implementation of the present application is limited to the description. Several simple derivation or replacements made by persons of ordinary skill in the art without departing from the idea of the present application all should be regarded as falling within the protection scope of the present application.

What is claimed is:

1. An iced conductor sleet jump simulation testing method, comprising the following steps:
(1) setting a maximum value (σ_{I}) in a conductor stress under a given typical meteorological condition combination to a conductor allowable maximum use stress and obtaining a stress (σII) of the conductor under a testing meteorological condition by using the following conductor stress state equation:
$${σ}_{I} - \frac{{EL}^{2} {γ}_{I}^{2}}{24 {σ}_{I}^{2}} + α {Et}_{I} = {σ}_{II} - \frac{{EL}^{2} {γ}_{II}^{2}}{24 {σ}_{II}^{2}} + α {Et}_{II} , \qquad$$
wherein:
the subscript I represents a typical meteorological condition, the subscript II represents a testing meteorological condition, σ_{I} is a conductor middle-span allowable maximum stress, σ_{II} is a conductor middle-span stress under the testing meteorological condition, E is a comprehensive elastic coefficient of the conductor, α is a coefficient of thermal expansion, t_{I} is a temperature under the typical meteorological condition, t_{II} is a temperature under the testing meteorological condition, γ_{I} is a relative load of an overhead conductor under the typical meteorological condition, γ_{II} is a relative load of the overhead conductor under the testing meteorological condition, and
$$γ = \frac{q}{A} ,$$
wherein q is a load withstood by the conductor of a unit length, A is a sectional area of the conductor, and L is a representative span of a strain section;
(2) according to the conductor stress and the load obtained in step (1), obtaining a displacement initial state of the conductor by using the following conductor catenary equation:
$$y = \frac{{σ}_{0}}{γ} [ cosh \frac{γ}{{σ}_{0}} ( z - {z}_{0} ) ] + {y}_{0} ,$$
wherein:
z is a known horizontal coordinate of each point in a current testing span along a line direction, y is a to-be-measured-and-calculated vertical coordinate of each point, z₀ and y₀ are constant parameters:
$${z}_{0} = \frac{1}{2 γ I } ( γ {I}^{2} - 2 H {σ}_{0} )$$
$${y}_{0} = - \frac{1}{8 γ {σ}_{0} {I}^{2}} ( γ {I}^{2} - 2 H {σ}_{0} ) ,$$
and
an x coordinate of each point in a static state is consistent and given, wherein:
σ₀ is a stress of the lowest point of the conductor, and a relationship between σ₀ and the conductor middle-span stress σ_{H} satisfies:
$${σ}_{II} = \frac{{σ}_{0}}{cos β} ,$$
wherein β is a height difference angle, H is a height difference between two suspending points, and when the suspending point on the right side is higher than the suspending point on the left signal, the height difference is a positive value; and I is a span of each span of the strain section; and
(3) according to the displacement initial state, obtaining displacement and stress states of each point in the current testing span of the conductor at each to-be-tested moment by using the following conductor kinetic equation:
M\ddot{X}=P+F_{C}+T, wherein:
M, F_{C}, T, and P are a mass matrix, a damping matrix, a tension matrix, and an external force matrix respectively, the mass matrix M being a diagonal matrix; F_{C}=C\dot{X} wherein C is a damping coefficient; T=KX, wherein K a stiffness matrix related to x, y, z coordinates of an adjacent node and is represented as a ratio of a dynamic tension between two adjacent points and a deformation amount thereof; X is a displacement, \dot{X} is a speed, and \ddot{X} is acceleration; and X, \dot{X}, and \ddot{X} are all three-dimensional vectors and comprise three directions of x, y, z.

2. The iced conductor sleet jump simulation testing method according to claim 1, wherein: in step (1), a group of typical meteorological conditions is selected from multiple known groups of typical meteorological conditions to serve as the given typical meteorological condition, and the group of typical meteorological conditions is the group of typical meteorological conditions that makes a conductor stress closest to the conductor allowable maximum stress among the multiple groups of typical meteorological conditions.

3. The iced conductor sleet jump simulation testing method according to claim 1, wherein: in step (1), the representative span L of the conductor is calculated by using the following equation:
$$L = \sqrt{\frac{{\sum }_{1}^{n} {l}_{i 0}^{3}}{{\sum }_{1}^{n} {l}_{i 0}}} ,$$
wherein Iᵢ₀ a span of each span in an n-span conductor, i0=1, 2, . . . , n.

4. The iced conductor sleet jump simulation testing method according to claim 1, wherein: in step (1), the load q is calculated by using the following equation:
$$q = P = \sqrt{{( {P}_{1} + {P}_{2} )}^{2} + {P}_{3}^{2}} , wherein {P}_{1} = WG , \\ {P}_{2} = \frac{ρ π G ( b + d ) b}{{10}^{6}} , and$$
$${P}_{3} = {Av}^{2} ( d + 2 b ) ,$$
wherein:
W is the mass of the conductor, G is gravitational acceleration length, ρ is air density, b is the thickness of icing, d is the outer diameter of the conductor, and v is a wind speed.

5. The iced conductor sleet jump simulation testing method according to claim 1, wherein: in step (3), the displacement and stress states are measured and calculated by using an explicit direct integration algorithm based on a central difference, so that speed and acceleration vectors are:
$$\dot{X} ( t ) = \frac{X ( t + Δ t ) - X ( t - Δ t )}{2 Δ t} ; and$$
$$\ddot{X} ( t ) = \frac{X ( t + Δ t ) + X ( t - Δ t ) - 2 X ( t )}{Δ {t}^{2}} ,$$
wherein
Δt is a calculated step length, and Δt≦2/ωₙ, wherein ωₙ is a maximal order inherent vibration frequency of a system.
